(19) United States
(12) Patent Application Publication
(10) Pub. No.: US 2025/0170503 A1
(43) Pub. Date: May 29, 2025

(54) SCREEN CYLINDER WITH AXIALLY VARIABLE WEAR RESISTANT COATING THICKNESS

(71) Applicant: AIKAWA FIBER TECHNOLOGIES OY, Varkaus (FI)

(72) Inventors: Robert William GOODING, Montreal (CA); Mathieu HAMELIN, Candiac (CA); Benoit MARTINEAU, Magog (CA)

(73) Assignee: AIKAWA FIBER TECHNOLOGIES OY, Varkaus (FI)

(21) Appl. No.: 18/839,637

(22) PCT Filed: Jan. 19, 2024
(86) PCT No.: PCT/IB2024/050544

§ 371 Date: Aug. 19, 2024

(30) Foreign Application Priority Data
Jan. 23, 2023 (WO) PCT/IB2023/050553

(51) Int. Cl. B01D 29/44; B07B 1/22; B07B 1/46; D21D 5/16

(52) U.S. Cl. CPC B01D 29/445; B07B 1/22; B07B 1/4618; D21D 5/16; B01D 2201/0415

(57) ABSTRACT

A screen cylinder includes a cylindrical screening media having an inflow side and an outflow side. The screening media is formed of a plurality of circumferentially spaced and axially extending wedgewire bars, which have an inflow surface facing the inflow side. The axially extending wedgewire bars have a wear resistant coating on their inflow surface. The wear resistant coating is substantially uniform in thickness on the inflow surface at individual axial locations but thicker on the bars on the inflow surface towards the outflow end of the screening media compared to the wear resistant coating located on the bars towards the inflow end of the screening media.

This application claims priority to International Application No.: PCT/IB2023/050553, filed on Jan. 23, 2023. The entire disclosure of this application are hereby incorporated herein by reference.

### FIELD OF THE INVENTION

The present application generally relates to screen cylinders for removing oversized solid contaminants from solid-in-liquid suspensions such as pulp and, in particular, screen cylinders having improved wear resistant characteristics and methods of making and using the same.

### BACKGROUND

Papermaking involves the processing or production of pulp, which is a solid-in-liquid suspension of fibers, such as cellulose fibers or other fibers. Pulp often includes various contaminants such as wood fragments, fiber bundles, metal pieces, hardened adhesives, or other contaminants. This is particularly the case where paper is made from recycled paper as a source of the pulp as such recycled paper pulp may be prone to the presence of hardened adhesives, metal fragments, and plastic particles therein. These contaminants, if not removed, will likely decrease the quality of the paper and/or interfere in the paper-making processes.

To remove the contaminants including oversized particles or fibers, the pulp is often screened. Screening may also be used to fractionate the pulp into streams with different fiber size distributions. Pulp screening can be accomplished by introducing the pulp to a pulp screen in which the acceptable portions of the pulp pass through openings such as slots within the screen. The oversized solid contaminants or other unacceptable portions of the pulp will not pass through the slots or openings within the screen and will exit from an outflow end of the screen as rejects via an outlet. Pulp screens may also be used for removing oversized and other solid contaminants from slurries and solid suspensions other than pulp.

Pulp screening can be accomplished using a screen cylinder located within a pulp screen. A screen cylinder can screen many types of fibers, such as but not limited to, cellulose fibers, cotton fibers, fiberglass fibers, or other fibers. The screen cylinder can be an inward-flow screen cylinder, in which the acceptable portions of the solid suspension flow radially inward through the screen cylinder, or an outward-flow screen cylinder, in which the acceptable portions of the solid suspension flow radially outward through the screen cylinder. The pulp screen may include a rotor or other device operable to accelerate the pulp suspension to create the desirable flow conditions at the entries to the apertures in the screen cylinder, as well as to create pressure pulsations that backflush blockages from the screen cylinder apertures. Each of these actions promotes the passage of acceptable pulp through the screen slots while restricting the passage of contaminants and undesirable pulp. Some screen cylinders utilize a solid metal cylinder through which a plurality of holes or slots are drilled or milled. However, to improve the throughput of the pulp screening process, screen cylinders that include a plurality of longitudinally-arranged, contoured wedgewire bars, which form a plurality of slots therebetween extending for most of the length of the screen cylinder, are generally preferred for pulp screening.

These wedgewire screen cylinders are typically made by arranging a plurality of wedgewire bars in a cylindrical shape. Slots formed between the wedgewire bars allow desirable pulp to pass therethrough while preventing undesirable pulp or other contaminants from also passing through. Thus the slot size of a screen cylinder is chosen based upon pulp parameters and such desired results. However, pulp is abrasive and causes the screen cylinder and the bars forming the same to wear out after some use. Wear of the screen cylinder may affect the performance and/or efficiency of the screen cylinder.

Wear resistant coatings such as chrome have been applied to the bars that form the slots in the screen cylinder to help minimize wear of the bars and thus the cylinder. Chrome coatings are applied using an electroplating process where the cylinder is in a bath of chromic acid and other chemical components. The cylinder acts as a cathode during the electroplating process and chrome is thus deposited on the wedgewire bars. However, chrome coatings may be difficult to apply consistently on the surface of the bars due to the variability of various factors in the electroplating process including: the current flow, the temperature of the acid bath, the gap between the anode and cathode (i.e. the cylinder), and the chemical strength of the acid bath. Also, wear resistant coatings may be applied to the bars by known coating or spraying methods, such as but not limited to, high-velocity oxygen fuel (HVOF) spraying, plasma spraying, laser spraying, chemical vapor deposition (CVD), physical vapor deposition (PVD), and atomic layer deposition (ALD).

In any event, screen cylinders tend to wear unevenly, and most typically, with the majority of wear occurring towards the outflow end of the screen cylinder. The outflow end of the screen cylinder, towards or near the rejects outlet, may wear at a greater rate than the inflow end of the screen cylinder due to a higher concentration of rejects flowing at the outflow end of the cylinder. It is not uncommon for a screen cylinder to wear prematurely because the surfaces of the wedgewire bars near the outflow end have worn out, while the surfaces of the same bars near the inflow end have not worn out. In this situation, the entire screen cylinder screening medium may need to be replaced, even though only the end near the outflow end of the same has worn out.

It is therefore desirable to achieve a screen cylinder with a screening medium which resists wear at an increased rate towards the outflow end of the screen cylinders and wedgewire bar surfaces proximate the outflow end. Furthermore, it is desirable to utilize wear resistant coatings which can be applied by spraying without negatively affecting the certain characteristics of the screening medium such as slot width as well as uniformity of the profile of the bars.

### SUMMARY OF THE INVENTION

Accordingly, an ongoing need exists for a screen cylinder having a wear resistant coating where the coating is applied preferentially on specific desired locations of the bars and/or sections of the screen cylinder, such as a thicker coating at or near the outflow end of the screen cylinder without negatively affecting the certain characteristics of the screening medium such as slot width as well as uniformity of the profile of the bars. In addition, it is preferred that the use of any coating result in a coating, which when viewed from an axial direction, at a section of the width of a bar is substantially uniform in thickness in the direction along the inflow surface of the bars. Such uniformity will thus not substantially alter the profile along the inflow surface of the bars when viewed from such direction.

According to one or more aspects, a screen cylinder includes a cylindrical screening media having an inflow side and an outflow side. The screening media is formed of a plurality of circumferentially spaced, axially extending, slots formed between axially extending wedgewire bars. The axially extending bars of the screening media have an inflow surface facing the inflow side. The screen cylinder and screening media have an inflow end and an outflow end axially opposite the inflow end. The axially extending bars comprise a wear resistant coating on the inflow surface of the screening media. The wear resistant coating is thicker on the bars towards the outflow end of the screening media compared to the wear resistant coating located on the bars towards the inflow end of the screening media. Each bar in the screen cylinder has a thicker wear resistant coating towards the outflow end of the screening media compared to the coating on each bar located towards the inflow end of the screening media. The wear resistant coating forms a substantially uniform coated area between an area on the inflow surface of a bar proximate a first slot to an area on the inflow surface of a bar proximate a second slot. The substantially uniform coated area at multiple axial locations of a bar is of a substantially uniform thickness along the inflow surface in a circumferential direction normal to the axial direction while the substantially uniform coated area increases in thickness at multiple axial locations along the axial direction or the bar. The wear resistant coating is preferably a sprayed on wear resistant coating of a hardness harder than the base material. The wear resistant coating is typically a high velocity oxygen fueled coating, and preferably formed of a homogeneous layer of a single coating, which may be formed of multiple sublayers where each sublayer is of a similar coating material, without the use of other coatings including, for example, chrome.

The screen cylinder may include a plurality of profiled wedgewire bars aligned longitudinally and coupled to at least one support ring at the attachment ends of the bars. Each of the bars typically extends the length of the screen cylinder. Each bar includes an inflow surface facing away from the at least one support ring, a first slot surface extending from the inflow surface to the attachment end of the bar opposite the inflow surface, and a second slot surface opposite the first slot surface and extending from the inflow surface to the attachment end of the bar. The first slot surface of one bar and the second slot surface of another adjacent bar may define a slot. The wear resistant coating may be applied on the inflow surface of the bars using a spray nozzle by passing the spray nozzle multiple times along the length of the bars while the screen cylinder is rotating or between incremental rotations of the screen cylinder, resulting in spray passes of the spray nozzle wherein the wear resistant coating is sprayed onto the inflow surface of the bars during the passes of the spray nozzle. The wear resistant coating forms a substantially uniform coated area between an area on the inflow surface of a bar proximate a first slot to an area on the inflow surface of a bar proximate a second slot. The substantially uniform coated area at multiple axial locations of a bar is of a substantially uniform thickness along the inflow surface in a circumferential direction normal to the axial direction while the substantially uniform coated area increases in thickness at multiple axial locations along the axial direction or the bar. The wear resistant coating is applied so as to be thicker on the bars towards the outflow end of the screening media compared to the wear resistant coating located on the bars towards the inflow end of the screening media. In other words, the wear resistant coating on each and all of the bars of the screen cylinder have a coating which increases in thickness more towards the outflow end of the screen cylinder.

According to still another aspect of the present disclosure, a method of making a screen cylinder is provided. The method includes forming a cylindrical screening media having an inflow side and an outflow side when the screening media has a plurality of circumferentially spaced axially extending slots formed between axially extending bars, the axially extending bars of the screening media having an inflow surface facing the inflow side. The screen cylinder and screening media include an inflow end and an outflow end axially opposite the inflow end. The method also includes applying a wear resistant coating on the inflow surface of the axially extending bars of the screening media. The wear resistant coating forms a substantially uniform coated area between an area on the inflow surface of a bar proximate a first slot to an area on the inflow surface of a bar proximate a second slot. The substantially uniform coated area at multiple axial locations of a bar is of a substantially uniform thickness along the inflow surface in a circumferential direction normal to the axial direction while the substantially uniform coated area increases in thickness at multiple axial locations along the axial direction or the bar. The wear resistant coating is thicker on each of the bars towards the outflow end of the screening media compared to the wear resistant coating located on the bars towards the inflow end of the screening media. The screen cylinder may be formed using wedgewire bars providing a profiled bar that includes an attachment end and an inflow surface facing in a direction opposite the attachment end. The wedgewire bar may further include a first slot surface extending from the inflow surface to the attachment end of the wedgewire bar and a second slot surface opposite the first slot surface and extending from the inflow surface to the attachment end.

In some aspects of the screen cylinder, the substantially uniform coated area varies in thickness along the inflow surface in a direction normal to the axial direction by an amount of twenty percent or less of an average thickness, preferably fifteen percent or less of an average thickness, preferably by an amount of ten percent or less of an average thickness, and/or more preferably five percent or less of an average thickness. The wear resistant coating comprises a material of a hardness greater than a base material of said bars. The axially extending slots of the screen cylinder may have a slot width defined by the minimum distance between adjacent bars at an area between said bars which are uncoated by the wear resistant coating such that the slot width is not reduced by said wear resistant coating at said area. Also, the minimum distance between coated areas of adjacent bars is preferably greater than or equal to a slot width defined by the minimum distance between adjacent bars at an area between said bars which are uncoated by the wear resistant coating. And, the slot width is preferably not reduced or coated by the wear resistant coating.

The substantially uniform coated area at the inflow surface of a bar may begin anywhere from within 0 mm to 0.7 mm from the upper ridge, but in some embodiments should be as close to the upper ridge as possible including at the upper ridge. The substantially uniform coated area may extend to at least anywhere within 0 mm to 0.7 mm from the transition area, but in some embodiments should be as close to the transition area as possible including at the transition area. Thus, it is preferred that the substantially uniform coated area be between 0.7 mm or closer to the upper ridge (including at the upper ridge) and 0.7 mm or closer to the transition area (including at the transition area). The upper ridge area is the area between a first slot surface of a bar and the inflow surface of a bar, and the transition area is the area between a second slot surface of a bar and the inflow surface of a bar.

In aspects of the screen cylinder and method of making the same, the wear resistant coating thickness increases from inflow end to outflow end along the axial length of the bars. The wear resistant coating thickness may progressively increase from inflow end to outflow end along the axial length of the bars. The wear resistant coating thickness may progressively increase at linear rate, or a greater than linear rate, from the inflow end to the outflow end along the axial length of the bars. The wear resistant coating thickness may progressively increase at a less than linear rate from the inflow end to the outflow end along the axial length of the bars. The wear resistant coating thickness may vary in a step-wise shape and progressively increase from the inflow end to the outflow end in the outflow direction along the axial length of the bars. The thickness of the wear resistant coating may vary in a wave form shape and progressively increase from the inflow end in the outflow direction along the axial length of the bars. The thickness of the wear resistant coating may increase from a nominal thickness of 30 or more microns to a nominal thickness of 300 or less microns. The thickness of the wear resistant coating may increase from a nominal thickness of 75 or more microns to a nominal thickness of 150 or less microns.

The wear resistant coating is preferably sprayed on the inflow surface of the axially extending bars of the screening media using a spray nozzle. The spray nozzle is moved axially in spray passes within the screen cylinder and the cylinder rotated to apply the wear resistant coating on the inflow surface of each of the axially extending bars of the screening media. The number of passes, or the speed of passes of the spray nozzle may be varied, while spraying the wear resistant coating to vary the thickness of the wear resistant coating along each bar. Each spray pass may deposit an additional layer of wear resistant coating along each of the bars. By increasing the number and/or duration of the passes towards the outflow end of the cylinder, the thickness of the entire coating on each of the bars towards the outflow end of the cylinder may be increased more than towards the inflow end.

The method may be performed while the screen cylinder rotates while spraying the wear resistant coating. The speed of rotation of the screen cylinder may vary based upon the position of the spray nozzle. The thickness of the wear resistant coating may increase from a thickness of 30 or more microns to a thickness of 300 or less microns. The thickness of the wear resistant coating may increase from a thickness of 75 or more microns to a thickness of 150 or less microns.

The foregoing general description and the following detailed description describe various embodiments and provide an overview or framework for understanding the nature and character of the claimed subject matter. The invention, however, is in no way limited to the specific disclosed embodiments.

### BRIEF DESCRIPTION OF THE DRAWINGS

The accompanying drawings are included and constitute a part of this specification. The drawings illustrate the various embodiments described herein, and together with the description serve to explain the principles and operations of aspects of the invention.

FIG. 1 schematically depicts a front perspective view of a screen cylinder, according to one or more embodiments shown and described herein;

FIG. 2 schematically depicts a perspective view of a portion of the screen cylinder of FIG. 1 showing a plurality of profiled or contoured bars coupled to support rings of the screen cylinder, according to one or more embodiments shown and described herein;

FIG. 3 schematically depicts a sectional view of five profiled bars of the screen cylinder of FIG. 1, the profiled bars having a wear resistant coating on an inflow surface of the profiled bars;

FIG. 4A-4D depict schematic side-view representations of wedgewire bars having a wear resistant coating with an increasing thickness towards the outlet end of the screen cylinder where the coating increases linearly, greater than linearly, stepwise and in a waveform, respectively, according to one or more embodiments of the invention shown and described herein;

FIG. 5 depicts a cut-away view of a screen cylinder with a robotic arm having a spray nozzle at an end thereof to spray the wear resistant coating onto the inflow surfaces of the bars;

FIG. 6 depicts a front perspective view of a screen cylinder on a rotatable platform along with a robotic arm having a spay nozzle used to apply the wear resistant coating; and

FIG. 7 depicts a schematic representation of a technique to vary the thickness of the wear resistant coating applied to the inflow surfaces of the bars on a screen cylinder by varying the length of the passes of the spray nozzle.

FIG. 8 depicts a sectional view in the axial direction of a wedgewire profiled bar in accordance with another embodiment of the present invention.

### DETAILED DESCRIPTION

Although the specifics of the screen cylinder described herein follow from an example of a typical screen cylinder, screen cylinders may vary in construction and features. For example, some screen cylinders may incorporate a structural backing plate on the outside of the screen cylinder to support the structure of the screen cylinder. Such a construction is shown and described in U.S. Pat. No. 5,200,072 issued on Apr. 6, 1993, which is incorporated by reference herein in its entirety. The structural backing plate may allow for less support rings on the screen cylinder. In any event, the benefits and features of the invention described herein are achievable and useable in different types of screen cylinders including, but not limited to, screen cylinders with or without a structural backing plate.

Reference will now be made in detail to embodiments of screen cylinders having profiled wedgewire bars, examples of which are illustrated in the accompanying drawings. The same reference numerals will be used throughout the drawings to refer to the same or like parts.

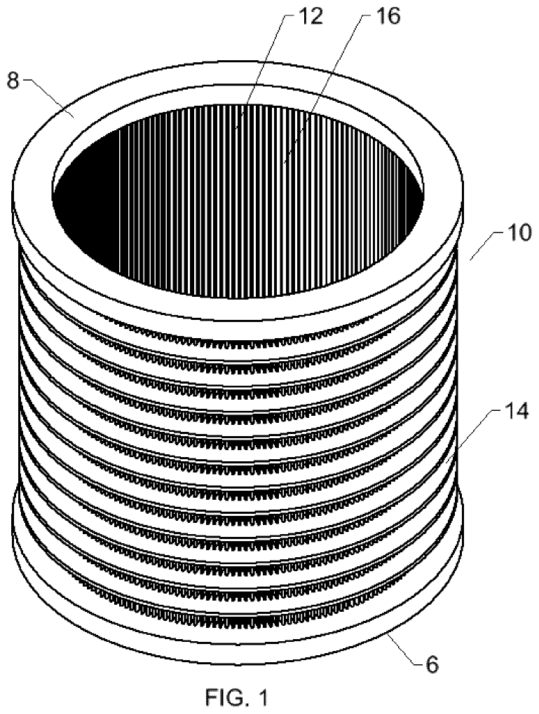

Referring to FIG. 1, an example of a screen cylinder 10 according to embodiments of the present disclosure is illustrated. The screen cylinder includes an inflow end 8 at an axial end thereof and an outflow end 6 at the opposite axial end thereof. Pulp or a similar fibrous suspension enters the cylinder at the inflow end 8 and a reject flow (including undesirable constituents) exits the cylinder at the outflow end 6. Accepts, or desirable pulp, pass through the screening media radially and are collected for later use or further processing.

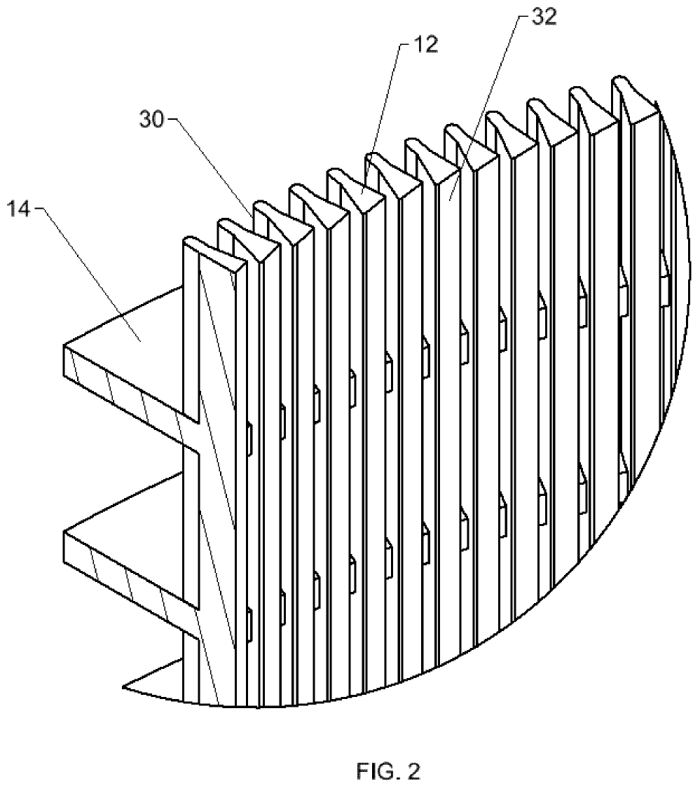

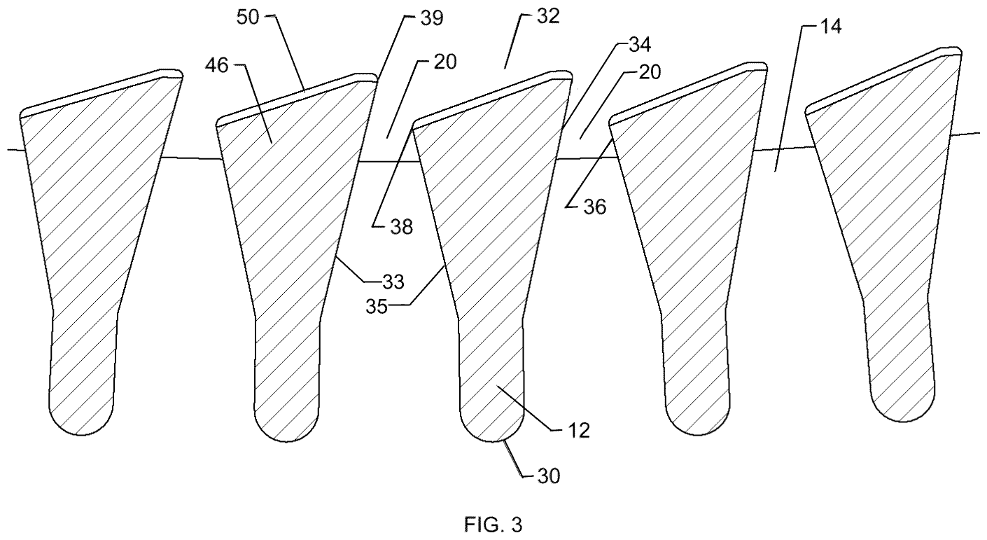

The screen cylinder 10 may include a plurality of profiled wedgewire bars 12 aligned longitudinally and coupled to at least one support ring 14 at attachment ends of the plurality of profiled bars 12. The profiled bars form a slotted cylindrical wall 16. Referring to FIGS. 2 and 3, each of the profiled bars 12 may include an inflow surface 32 facing away from the support ring 14, a first slot surface 33 extending from the inflow surface 32 to the attachment end 30 of the profiled bar 12, and a second slot surface 35 opposite the first slot surface 33 and extending from the inflow surface 32 to the attachment end 30 of the profiled bar 12. The first slot surface 33 of one profiled bar and the second slot surface 35 of another adjacent profiled bar may define a slot 20 (FIG. 3). Each of the profiled bars may include a wear resistant coating as part of and on at least the inflow surface of the profiled bar 12. The wear resistant coating has an increasing thickness towards the outflow end of the screen cylinder. The inflow surfaces 32 of the bars are located on the inflow side of the screening medium and cylinder. The attachment ends 30 of the bars are located on the outflow side of the screening medium and cylinder.

During operation of the screen cylinder 10 acceptable portions of the pulp or other solid suspension flow through the slots 20 (see FIG. 3) in the slotted cylindrical wall 16. The wear resistant coating applied to the profiled bars 12 may reduce wear of the profiled bars 12 caused by the abrasive solid constituents of the pulp. Reducing wear on the bars and their inflow surfaces located towards the outlet end of the screen cylinder may help maintain the performance and efficiency of the screen cylinder 10 over time, as the inflow surfaces of the bars located near the outlet tend to wear at an increased rate, causing a need to replace the entire screen cylinder. Thus, reducing wear towards the outflow end of the screen cylinder 10 over time may increase the service life of the screen cylinder.

Directional terms as used herein, for example up, down, right, left, front, back, top, bottom, are made only with reference to the figures as drawn and the coordinate axis provided therewith and are not intended to imply absolute orientation. Also, references to a thickness including the thickness of a wear resistant coating include and refer to a nominal thickness, which is a desired thickness. And as explained herein, when referring to the wear resistant coating as substantially uniform, the actual coating thickness may vary up to 20% from the average thickness. For example, an average thickness of 100 microns for a coating may vary anywhere by up to 20 percent and be substantially uniform in thickness. And, some areas of the inflow surface, particularly near the slot surfaces, may be uncoated.

As used herein, the singular forms “a”, “an” and “the” include plural referents unless the context clearly dictates otherwise. Thus, for example, reference to “a” component includes aspects having two or more such components, unless the context clearly indicates otherwise.

As used herein, the term “longitudinal” or “axial” may refer to an orientation or direction generally parallel with the center axis of the screen cylinder.

As used herein, the term “radial” may refer to a direction along any radius which extends outward from the center axis of the screen cylinder (FIG. 1).

As used herein, the terms “inflow” and “outflow” may refer to relative positions of features with respect to a direction of flow of the solid suspension or slurry, as inflow when entering the slots and outflow when exiting the slots. For the wedgewire bars of the present disclosure, the flow of solid suspension is generally from the inflow surfaces 32 of the profiled bars 12 towards the outflow attachment ends 30 of the profiled bars 12. So, for example, the “inflow direction” or “towards the inflow direction” refers to the direction away from the inflow surface radially opposite or upstream the direction of flow. However, the “outflow direction” or “towards the outflow direction” refers to the direction away from the inflow surface radially with or downstream the direction of flow, which is opposite the inflow direction. “Upstream” and “downstream” refer to flow locations relative to one another where the flow of the solid suspension moves from upstream to downstream. For the screen cylinder inflow end refers to the end of the screen cylinder where the pulp enters, while the outflow end refers to the end where the reject pulp exits. Also, the direction of the flows as described above refers to the general motion of the flow averaged over space and time-respecting that there may be flow recirculation through the cylinder and instantaneous flow reversals, such as slot backflushing actions.

As used herein, the term “solid contaminant” or “oversized solid contaminant” may refer to solid objects, such as fiber bundles, metal pieces, dried adhesives, plastic specks or other contaminants, that are not intended to be and not desired in the solid suspension or slurry and may be distinguished from the solid constituents that are intended to be in the solid suspension, such as fibers for example.

Referring to FIGS. 1 and 2, a screen cylinder 10 which includes a plurality of wedgewire profiled bars 12 is schematically depicted. The screen cylinder 10 includes a plurality of support rings 14. The screen cylinder 10 includes the plurality of such bars 12 aligned longitudinally and coupled to at least one support ring 14 at attachment ends 30 of the bars 12. The screen cylinder 10 may also include annular end flanges at either axial end of the screen cylinder 10. Although not shown in the drawings herein, the screen cylinder will normally include a rotor therein to accelerate the suspension circumferentially and to create pressure pulsations which facilitate the flow of pulp through the slots of the screen cylinder. Details on construction of a screen cylinder and their operation may be found in U.S. Pat. Nos. 7,188,733, 7,856,718, and 5,200,072, the entire contents of each of which are incorporated by reference herein.

Each of the bars 12 may be longitudinally aligned and circumferentially spaced about a center axis of the screen cylinder 10 with each of the other bars 12 and at a particular radial distance. The bars 12 may be arranged side-by-side along a circular inner or outer circumference of the support ring 14 to form a slotted cylindrical wall 16. The slotted cylindrical wall 16 formed by the plurality of bars 12 may include slots 20 defined between each adjacent pair of bars 12. The slots 20 may extend the length of the screen cylinder 10 between the two annular end flanges.

By having slots 20 extending the length of the screen cylinder 10, the screen cylinder 10 comprising the plurality of profiled bars 12 may generally provide increased open area through which acceptable pulp or other solid suspension can flow. The screen cylinder 10 is depicted in FIGS. 1 and 2 as an outward flow screen cylinder 10 in which the acceptable solid suspension flows radially outward through the slots 20 (FIG. 3). However, the features of the present disclosure may also be used with an inward flow screen cylinder or any other type of pressure screen device utilizing a plurality of profiled bars. The screen cylinder 10 may be operable to separate solid contaminants from the solid suspension.

Referring to FIG. 3, a cross sectional view of an embodiment of the profiled bars 12 mounted on a support ring 14 of a screen cylinder is depicted. Each of the bars 12 may have an attachment end 30 coupled to the support rings 14. Each of the bars 12 may have an inflow surface 32 facing primarily away from the at least one support ring 14. The inflow surfaces 32 of the plurality of bars 12 form the slotted cylindrical wall 16 (FIG. 1) of the screen cylinder 10. Still referring to FIG. 3, each of the bars 12 may have a first slot surface 33 extending from the inflow surface 32 to the attachment end 30 of the profiled bar 12, which is opposite the inflow surface 32. Each of the profiled bars 12 may have a second slot surface 35 on an opposite side from the first slot surface 33 and extending from the inflow surface 32 to the attachment end 30 of the profiled bar 12. The first slot surface 33 and second slot surface 35 face away from the inflow surface 32 and towards the support ring 14. The first slot surface 33 of one profiled bar 12 and the second slot surface 35 of another adjacent profiled bar 12 define one of the slots 20 of the screen cylinder 10. When two profiled bars 12 are adjacent, the first slot surface 33 of the first profiled bar and the second slot surface 35 of the second profiled bar define the slot 20 with no other profiled bars disposed between the first and the second profiled bars. The slot width is defined as the closest distance between the first slot surface 33 and the second slot surface 35 of adjacent bars.

The first slot surface 33 may have a flat surface shape, and the second slot surface 35 may also have a flat surface shape. The first slot surface 33 may meet the inflow surface 32 at an upper ridge 39 that protrudes radially away from the support ring 14, e.g., inward, and towards an adjacent bar located counter-clockwise therefrom. The upper ridge 39 may include a curve or corner between the inflow surface 32 and the first slot surface 33. Downstream from first slot surface 33 the bar side surface has a slight contour variation between the upper ridge 39 and the attachment end 30. The second slot surface 35 may meet the inflow surface 32 of the profiled bar 12 at a radially lower ridge or transition area 38 that connects to the inflow surface 32. Downstream of the transition area 38 and second slot surface 35 of the profiled bar 12 the side surface of the bar may connect to the attachment end 30 of the bar. As previously discussed, the flow of the solid suspension through the slots 20 is generally from the inflow surface 32 of the profiled bars 12 towards the attachment ends 30. The transition area 38 connects the second slot surface 35 to the inflow-facing surface 32, with a corner or curve therebetween. The wedgewire bars, however, may have shapes other than those depicted in FIG. 3. For example, the inflow surface 32, the first slot surface 33 and the second slot surface 35 may have any suitable shape for producing a screen cylinder for removing oversized solid contaminants from slurries and solid suspensions.

For a screen cylinder 10 for screening paper pulp, the slot 20 may have a slot width that is greater than or equal to 80 microns (0.08 mm), such as from 0.08 mm to 1.5 mm. However, for applications in other industries, the spacing between profiled bars 12 and slot widths may be larger or smaller depending on the specific industry application. The slot width of the slot 20 should be consistent along the longitudinal length of the profiled bars 12.

Referring to FIG. 3, a wear resistant coating 50 is located on and as part of the inflow surface 32 of the bars 12. FIG. 3 shows a sectional view at a section of a bar in the axial direction. However, FIG. 3 only depicts one slice of the bars at the same axial location and for simplicity does not depict the section of the coating of increased thickness located towards the outlet end of the cylinder. Wear may cause the erosion of the inflow surface 32, which will disrupt its hydrodynamic performance and reduce the flow through the screen cylinder. With wear of the inflow surface, its contour or profile will change shape and the hydraulic capacity of the screen will be reduced and the slots may be more prone to plugging. Contour wear generally increases axially. As a result, when used to remove solid contaminants from a solid suspension of cellulose fibers or other solid constituents, the screen cylinder without a wear resistant coating may have a reduced service life. In some cases, the service life may be reduced to only a few months. The wear resistant 50 coating, in this embodiment, is applied to the entire length of the bars 12, but its thickness increases at, near, and/or towards the outflow end 6 of the bars 12 and screen cylinder 10. However, at any given axial location, and preferably at all axial locations, the thickness of the bar is substantially uniform in the direction normal to the axial direction (as shown in FIG. 3). In other embodiments, the wear resistant coating may not be applied to areas near the inflow end 8 of the bars 12. The wear resistant coating on the inflow surface thus impedes the surface from prematurely wearing. The coating, however, is not applied to the slot surfaces 33, 35 of the bars in such a way as to reduce the minimum width of slot 20, or “slot width”, which is defined as the minimum distance between the first slot surface 33 and second slot surface 35, which is typically located between point 34 and transition area 38 of the first and second slot surfaces, respectively.

Each of the profiled bars 12 may be formed from a base metal 46 upon which the wear resistant coating is applied. The base metal 46 may be a rigid metal having strength sufficient to withstand the pressure pulses from the rotor and other mechanical loads, without deforming or breaking. In some embodiments, the base metal 46 may be stainless steel, such as 304L stainless steel or 316L stainless steel. The base metal 46 without the wear resistant coating 50 may have a hardness value less than the hardness value of the wear resistant coating 50. For example, the base metal 46 may have a hardness of less than 500 HV0.05.

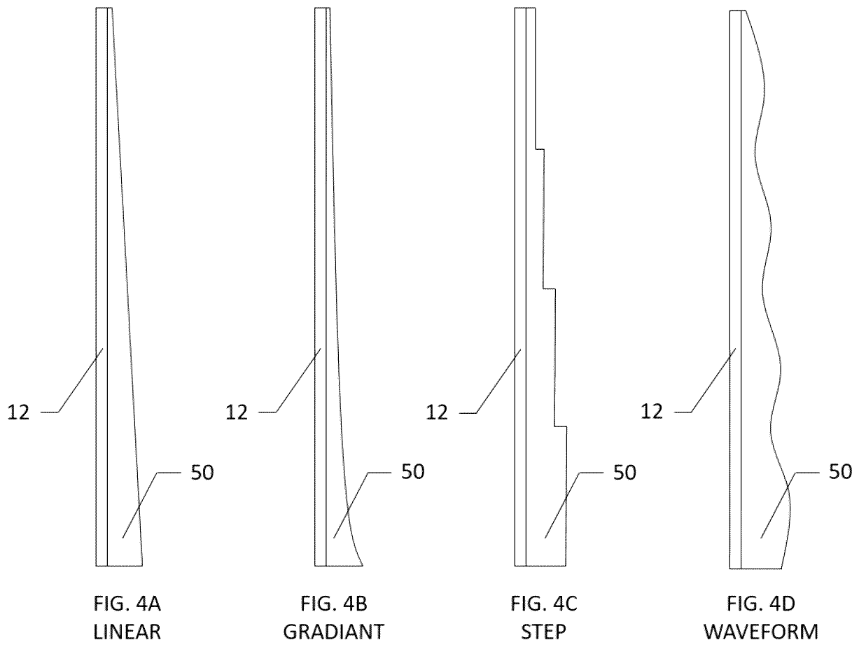

Referring to FIG. 4A-4D, representations of some examples of the axial profile for the wear resistant coating gradients in accordance with aspects of the invention are shown. The wear resistant coating 50 is coated onto the base metal 46 of each of the profiled bars 12 in the screen cylinder using a shape consistent with those shown in FIG. 4A-4D. However, FIG. 4A-4D show an exaggerated thickness of the coating 50 for illustrative purposes. The wear resistant coating 50 is sprayed on the inflow surface 32 of the profiled bars. As previously discussed, the inflow surface 32 proximate and the outflow end of the screen cylinder may be the region that experiences the greatest wear. So, the maximum effect of the wear resistant coating 50 should occur at this location of the screen cylinder, namely, at and towards or near the outflow end. The wear resistant coating 50 may have a thickness profile sufficient to protect the outflow end of the screen cylinder from premature or excessive wear.

In FIG. 4A, a linear axial gradient for the wear resistant coating 50 is shown. Here the thickness of the coating increases at a linear rate towards the outflow end of the screen cylinder 6. The rate of the axial thickness increase can be chosen based upon the characteristics of the fibrous suspension being screened, the screen cylinder parameters, and the variation in wear rate towards the outflow end of the screen cylinder. For example, the thickness could increase from 0 microns at the inlet to 100 microns at the outlet, or from 50 microns at the inlet to 150 microns at the outlet. In another embodiment of the linear shape, there could be a section of constant coating thickness of, for example 50 microns thickness, beginning at the inlet to the cylinder and extending for one-third the length of the cylinder, followed by a section where the coating thickness increases linearly from 50 microns to 150 microns, followed by a section over the final one-third length of the cylinder, extending to the outlet where the coating thickness is of a constant thickness of 150 microns.

Also, in FIG. 4B a greater than linear increase in the axial gradient for the wear resistant coating 50 is shown. Here the thickness of the coating increases at a more than linear rate towards the outflow end of the screen cylinder 6, such as a power or exponential rate. The rate of increase in the slope of the thickness rate can be chosen based upon the characteristics of the fibrous suspension being screened, the screen cylinder parameters, and the variation in wear rate towards the outflow end of the screen cylinder. For example, the thickness could increase from 0 microns at the inlet to 10 microns at a distance one-third the length from the inlet, and then increase from 10 microns to 40 microns over the second one-third length of the cylinder, and finally from 40 microns to 100 microns over the final one-third length of the cylinder. In another embodiment of the gradient shape, there could be a section of constant coating thickness at the inlet to the cylinder of, for example, of 30 microns thickness, that might extend for one-quarter the length of the cylinder, followed by a section where the coating thickness increases from 30 microns to 40 microns over the next one-quarter length of the cylinder, followed by a section where the coating thickness increases from 40 microns to 70 microns over the next one-quarter length of the cylinder, followed by a section where the coating thickness increases from 70 to 130 microns over the last one-quarter length of the cylinder.

Also, in FIG. 4C a stepwise increase in the axial gradient for the wear resistant coating 50 is shown. Here the thickness of the coating increases at a stepwise rate, shape and/or pattern towards the outflow end of the screen cylinder 6. The frequency, distance and/or number of steps in the axial direction can be chosen based upon the characteristics of the fibrous suspension being screened, the screen cylinder parameters, and the variation in wear rate towards the outflow end 6 of the screen cylinder 10. In addition, the height or thickness increase for each step can also be chosen based upon the characteristics of the fibrous suspension being screened, the screen cylinder parameters, and the variation in wear rate towards the outflow end of the screen cylinder. For example, in one embodiment, the thickness could be 50 microns thick in the first step, which would extend over the first one-quarter-length of the cylinder beginning at the inlet; the thickness would then increase to 75 microns for the second step, which would extend over the next one-half length of the cylinder length; and finally the thickness would increase to 125 microns for the third step, which would extend over the final one-quarter length of the cylinder length.

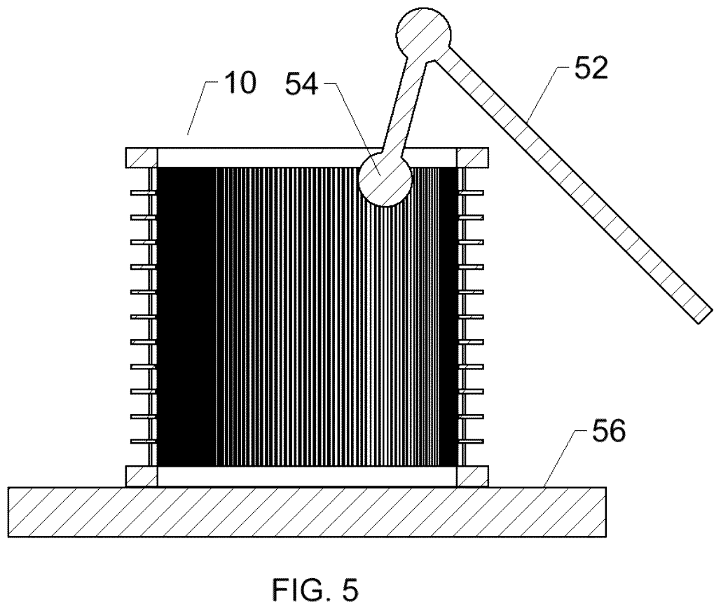

In FIG. 5D a wave form increase in the axial gradient for the wear resistant coating 50 is shown. Here the thickness of the coating increases at a curved or waveform rate, shape and/or pattern to the screen cylinder 6. The length, frequency, shape, distance and/or number of curves or waves in the axial direction can be chosen based upon the characteristics of the fibrous suspension being screened, the screen cylinder parameters, and the variation in wear rate towards the outflow end of the screen cylinder. In addition, the height or thickness increase for each curve or wave can also be chosen based upon the characteristics of the fibrous suspension being screened, the screen cylinder parameters, and the variation in wear rate towards the outflow end of the screen cylinder. For example, in one possible embodiment, the initial coating thickness might be 30 microns at the inlet end of the cylinder, which would increase to 50 microns at the end of the first quarter of the cylinder length; then decrease to 40 microns during the second-quarter of the cylinder length before increasing to 80 microns thickness at the end of the second-quarter of the cylinder length; then decrease to 70 microns thickness during the third quarter of the cylinder length before increasing to 120 microns thickness at the end of the third quarter of the cylinder length; and then finally for the thickness to decrease to 110 microns before increasing to 150 microns thickness at outlet end of the cylinder.

In addition, an axial gradient pattern may include combinations of the gradients shown in FIGS. 4A-4D. for example, an axial gradient of the coating may include a linear shape combined with a stepwise, gradient and waveform shape, or any combination or permutation of these shapes over different portions of the axial length of the bars. For example, the linear slope shown in FIG. 4A may be created to have some features of a step as shown in FIG. 4C and the step shown in FIG. 4C may be created to not have sharply distinct, axial faces on each stepwise increase.

For example, and without limitation, the wear resistant coating 50 may have a thickness greater than or equal to 5 microns, greater than or equal to 10 microns, greater than or equal to 15 microns, or even greater than or equal to 20 microns. In embodiments, the wear resistant coating 50 may have a thickness of from 5 microns to 300 microns, from 5 microns to 250microns, from 5 microns to 200 microns, from 5 microns to 100 microns, from 5 microns to 50microns, from 5 microns to 30 microns, from 10 microns to 300 microns, from 10 microns to 100microns, or from 10 microns to 50 microns. In some embodiments, the wear resistant coating 50may have a thickness of greater than 300 microns without departing from the scope of the present disclosure. For example, the wear resistant coating may increase progressively in thickness from about 5 microns to 300 microns.

The wear resistant coating 50 may have a hardness sufficient to reduce wear of the wedgewire bars 12 during operation of the screen cylinder 10. The wear resistant coating 50 may have a hardness greater than the hardness of the base metal 46 of the bars 12. For example, the wear resistant coating 50 may have a hardness value greater than the hardness value of cold-rolled stainless steel, which is about 400 HV0.05. The wear resistant coating 50 may have a hardness value between 500 HV0.05 to 1200 HV0.05. The hardness values may be determined through measurements performed in accordance with standard Vickers hardness test methods.

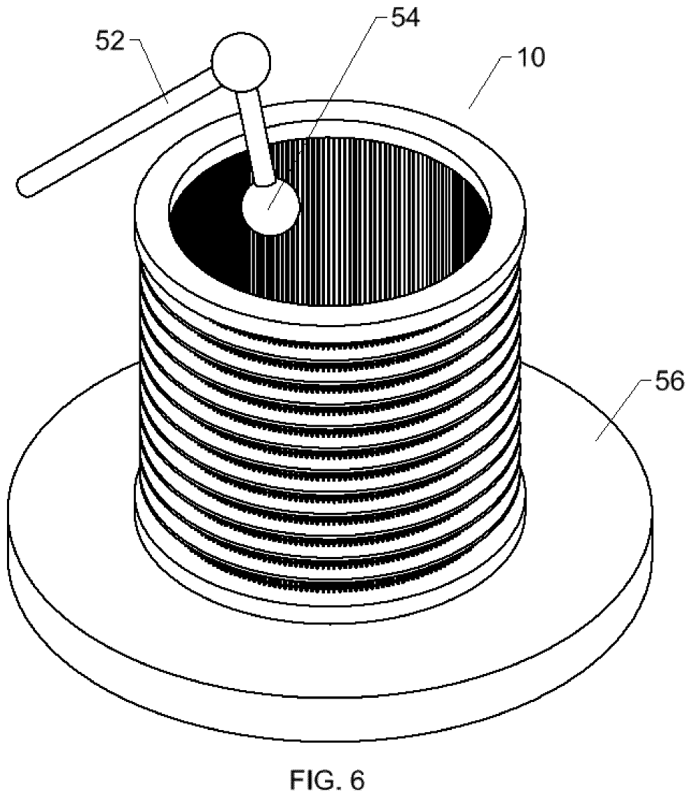

Referring to FIGS. 5 and 6, a system for applying the wear resistant coating to the screen cylinder 10 is shown. In this system, a robotic arm 52 includes a spray nozzle 54 at its end. The spray nozzle 54 is adapted to spray the wear resistant coating 50 on the inflow side of the screen cylinder and onto the inflow surfaces 32 of the bars. The robotic arm 52 is oriented to allow the spray nozzle 54 to travel axially inside the screen cylinder 10 along the entire inner axial length thereof. In some embodiments the spray nozzle 54 may not be able to travel along the entire inner axial length; in this situation the cylinder is coated along approximately half of its length and then flipped 180 degrees to coat the other half. The spray nozzle 54 moves at least in the axial direction and the radial direction relative to the screen cylinder 10. The spray nozzle sprays the wear resistant coating, for example, in the form of a thin cylindrical plume, typically about 7 mm in diameter. Each pass deposits, for example, a layer of coating about 10 microns thick. By varying the length, number and/or speed of the passes along the axial length of the cylinder, the thickness of the wear resistant coating 50 and its axial gradient or profile can be controlled. In one embodiment, the screen cylinder 10 can be rotated using a rotating platform 56 while the spray nozzle 54 applies the coating 50.

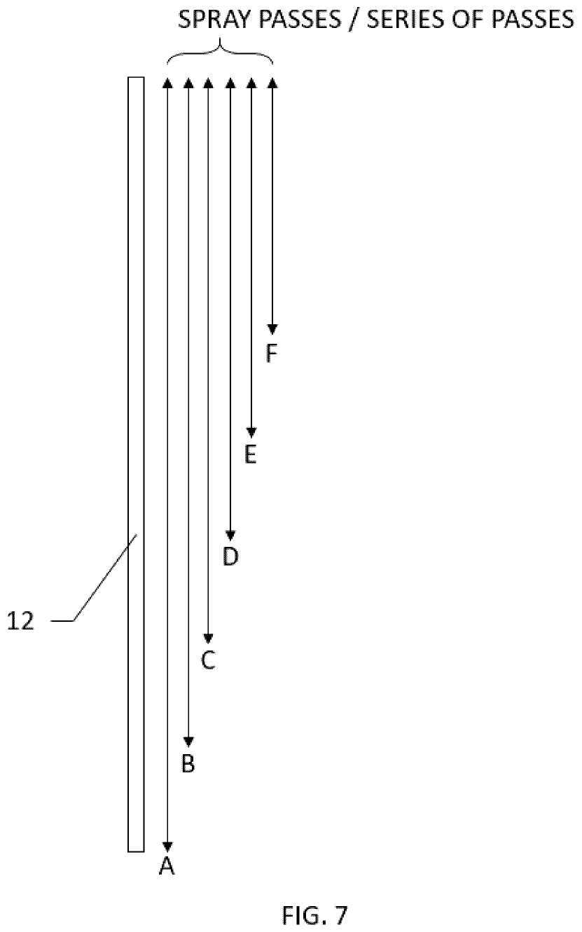

Referring to FIG. 7, a technique for applying the wear resistant coating 50 will now be described. Using this technique, the spray nozzle applies a 10 micron thick coating in each axial pass. The screen cylinder 10 may or may not be rotated about its central axis during each axial pass. Initially, the screen cylinder 10 is oriented so that the outlet end 6 is located at the top or beginning of each spray pass. A first series of axial passes A occurs where the spray nozzle 54 travels the entire axial length of the screen cylinder 10. Then, a second series of axial passes B occurs, but the length of each pass in the second series of axial passes is less than the length of each pass in the first series of axial passes. Then, a third series C of axial passes occurs, but the length of each pass in the third series of axial passes is less than the length of each pass in the second series of axial passes. Then, a fourth series D of axial passes occurs, but the length of each pass in the fourth series of axial passes is less than the length of each pass in the third series of axial passes. Then, a fifth series E of axial passes occurs, but the length of each pass in the fifth series of axial passes is less than the length of each pass in the fourth series of axial passes. Then, a sixth series F of axial passes occurs, but the length of each pass in the sixth series of axial passes travel is less than the length of each pass in the fifth series of axial passes. Each series of axial passes may include one or more axial passes, where a cycle is considered consecutive passes in the opposite direction, depending upon the desired axial profile thickness. Each series of axial passes can create a step or wave form, if desired. Also, additional series of spray passes of consecutively shorter lengths can be performed to customize the axial gradient of the wear resistant coating. The screen cylinder can be rotated about its central axis either during axial passes of the spray nozzle and/or between axial passes of the spray nozzle.

Also, by programming the speed of rotation of the screen cylinder and/or axial speed of the spray nozzle 54 while applying the coating of the spray nozzle, various different axial gradient profiles of increasing thickness may be achieved. Also, the speed of the axial movement of the spray nozzle and/or the speed of rotation of the screen cylinder can be decreased towards the outlet end of the screen cylinder to achieve various different axial gradient profiles of increasing thickness towards the outlet end of the screen cylinder. The speed of rotation of the screen cylinder and/or the length or speed of passes of the spray nozzle can be varied or adjusted in limitless ways to achieve various axial gradient profiles of increasing thickness. For example, the speed of rotation of the screen cylinder may vary based upon axial position of the spray nozzle.

Preferably, forming the wear resistant coating 50 may include applying a wear resistant coating 50 only to the inflow surface 32 of the profiled bars 12. Applying the wear resistant coating 50 may include any of the coating processes discussed herein, and the wear resistant coating 50 may be formed using any of the materials discussed herein. In some embodiments, applying the wear resistant coating to at least the inflow surface 32 may include a thermal spraying process. In some embodiments, the thermal spraying process may include a high velocity oxygen-fuel (HVOF) process.

The bars 12 forming the screening medium are coated on the inflow faces or surfaces 32 preferably using a high-speed flame spraying under combustion of a liquid or gaseous fuel. A high velocity flame nozzle such as a high velocity oxygen flame (HVOF) is used to apply the wear resistant coating to the inflow side faces of the bars. This technique leads to an integral bonding of the coating with the bar surface. The coating highly adheres to the bar surface and results in a dense grain structure thereon.

The wear resistant coating 50 can, for example, be a tungsten carbide and/or chromium carbide-containing hard metal coating. Basic elements, such as, for example, Ti, V, Nb, Mo, Ta and Hf, can also occur as carbides and can be used in carbide-containing wear resistant coatings. Cobalt, chromium and nickel carbides can be used in the wear resistant coatings as well. The screen cylinder bars can be coated with the wear resistant coating by thermal spraying. The coating material is completely or partially offset into a molten or plastic state, and is sprayed as finely distributed as a particle mist by means of a gas stream onto the bars to be coated distributed via the nozzle 54. Upon cooling, the coating is formed from particles mechanically adhering to the surface of the bars to be coated. Any material which has a stable melt state, for example metal, ceramic or alloys thereof, can be used as the coating material. Various thermal spraying methods for the wear resistant coating material include flame spraying, arc spraying, plasma spraying, vacuum plasma spraying, high-speed flame spraying, detonation spraying and explosion spraying. For example, high-speed flame spraying (HVOF, HVAF) can be used for the formation of hard metal coatings, for example WC-Co (Cr) and Cr3C2-NiCr. And, the wear resistant coating may exhibit a hardness between 500 HV0.05 to 1200 HV0.05. The hardness values may be determined through measurements performed in accordance with standard Vickers hardness test methods.

Using such techniques, a coating 50 with optimum hardness, wear resistance and fracture toughness can be achieved. Wear resistant thermally-sprayable hard metal coatings may contain, in addition to carbide, other hard particles such as nitrides, oxides or borides.

The base material of the bars 12 is typically stainless steel, but may be comprised of other metals and alloys. Preferably, the wear resistant coating 50 is applied to the inflow-side surface 32 or face of the bars at one or more predefined angles relative to the inflow side surface 32 or face of the bars, to ensure the desired coating profile. The wear resistant coating may be applied by one or a plurality of spray nozzles or a nozzle with multiple spray heads 54. The angle of the spray nozzles or head(s) may be set to 90 degrees relative to the flat inclined portion of the inflow surface. However, other spray angles may be used and/or, for example, the angle of the spray nozzle 54 may vary during subsequent spray passes thereof.

An angle of inclination of the spray nozzle 54 or heads relative to the flat inclined surface of the inflow surface of about 90 degrees is generally preferred. Preferably, multiple passes of the spray nozzle or heads are made over the screen to attain the coating profile desired. Multiple passes of the nozzle or spray heads are made over the screening medium to attain the coating profile required.

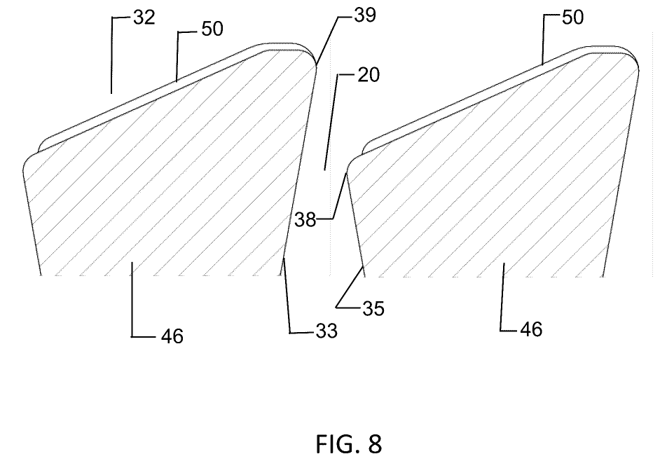

Referring to FIG. 8, the substantial uniformity in thickness on the inflow surface of a bar is shown. This uniformity in thickness is viewed at a section of a bar in the direction normal to the axial direction similar to a cross sectional view. However, FIG. 8 only depicts one slice of the bars at the same axial location and for simplicity does not depict the section of the coating of increased thickness located towards the outlet end of the cylinder. And when viewed from the axial a direction, the coated area on the inflow surface of the bar at a particular axial location has an average thickness. However, the uniformity of the coated area at any or all axial locations may vary up to 20% of the average thickness, and preferably up to 15%, preferably up to 10%, and most preferably up to 5% including all amounts between 0 and 5%. Thus, substantially uniform as used herein refers to coated area thickness varying up to 20% of the average thickness, and preferably up to 15%, up to 10%, and more preferably up to 5% including all amounts between 0 and 5%. Also, the thickness may actually slightly decrease from the area proximate the transition area 38 to the area proximate the upper ridge 39, but still remain substantially uniform. At any given axial location of a bar 12, and preferably, at all axial locations of the bars 12, the coating 50 is substantially uniform in the circumferential direction normal to the axial direction (as shown in the view in FIGS. 3 and 8). And, the bars 12 may be coated along their entire length or a portion of their entire length in the axial direction.

Also, as can be seen in FIG. 8, the substantially uniform coated area 50 may not extend the entire width of the inflow surface 32. In other words, the wear resistant coating may have some non-uniformity at the edges of the inflow surface 32. This non-uniformity may occur when the coating 50 is applied in individual passes where the thickness of the coating deposited in each pass is about 10 microns thick, one sub-layer at a time, where individual sub-layers may not perfectly align with the prior applied sub-layers. The sub-layers together form the coated area with a total thickness of the final layer as set forth herein. The substantially uniform coated area begins at the inflow surface 32 of a bar proximate the upper ridge 39 and could be within 0.0 to 0.7 mm from the upper ridge 39. Preferably, the substantially uniform coated area begins within 0.0 to 0.5 mm of the upper ridge 39, and more preferably within 0.0 to 0.2 mm of the upper ridge 39. However, it may also be most preferable that the substantially uniform coated area 50 begins at the upper ridge 39 itself such that there is no area between the upper ridge 39 and the substantially uniform coated area. The substantially uniform coated area 50 then extends in a direction normal to the axial direction on the inflow surface 32, e.g., circumferentially with respect to the screen cylinder, until it ends at the inflow surface 32 of the bar proximate a second slot at a location within 0.0 to 0.7 mm from the transition area 38. Preferably, the substantially uniform coated area begins within 0.0 to 0.5 mm of the transition area 38, and more preferably within 0.0 to 0.2 mm of the transition area 38. However, it may also be most preferable that the substantially uniform coated area begins at the transition area 38 itself such that there is no area between the transition area 38 and the substantially uniform coated area. A typical wedgewire bar 12 for pulp screening has a width of about 3.2 mm at its inflow surface. The most common wedgewire bars are between 2.6 to 3.6 mm in width. However, some bars may be as narrow as 2.3 mm and some as wide as 5.0 mm at the inflow surface, when used for pulp screening. In all possible widths at the inflow surface of the bars, including anywhere between 2.3-5.0 mm, the substantially uniform coated area may begin and end proximate the upper ridge 39 and transition area 38 as described above. The substantially uniform coated area may be most uniform at flat sections of the inflow surface by maintaining the nozzle (not shown) which spays the wear resistant coating at a constant angle relative to the flat surfaces on the inflow surface of the bars. For example, the inclined flat surface of the coated area 50 shown in FIG. 8 can be most uniform by maintaining the spray nozzle at a constant angle relative thereto when applying the coating 50.

Also, the axially extending slots have a slot width 20 defined by the minimum distance between adjacent bars at an area between said bars which are uncoated by the wear resistant coating. It is preferred that the wear resistant coating 50 is not applied to the slot surfaces particularly at the location of the slot such that the slot width is not effectively reduced by the presence of any wear resistant coating at said area. Also, it is preferred that the minimum distance between areas of adjacent bars with any coating material thereon is greater than or equal to the minimum slot width 20 such that the effective slot width 20 between adjacent bars is not reduced by application of the wear resistant coating. In this regard, application of the wear resistant coating 50 (or any overspray thereof) on the first slot surface 33 or the second slot surface 35, particularly upstream and slightly downstream of the slot width 20 at points 34 and 38, should be avoided.

As previously discussed herein, the screen cylinders 10 that include the profiled bars 12 having wear resistant coatings 50 may be used to process solid suspensions of cellulose or other fibers in the pulp in paper industry, as described herein. However, the screen cylinders 10 may not be limited to use in the pulp and paper industry. For example, screen cylinders 10 of the present disclosure having the coated profiled bars 12 may be used to screen solid suspensions and/or slurries to remove oversized solid contaminants in mining and drilling applications, food preparation and processing operations, water treatment processes, coating operations, and other industries.

While various embodiments of the profiled bars 12 for the screen cylinder 10 and methods for making and using the profiled bars 12 have been described herein, it should be understood that it is contemplated that each of these embodiments and techniques may be used separately or in conjunction with one or more embodiments and techniques. It will be apparent to those skilled in the art that various modifications and variations can be made to the embodiments described herein without departing from the spirit and scope of the claimed subject matter. Thus, it is intended that the specification covers the modifications and variations of the various embodiments described herein provided such modifications and variations come within the scope of the appended claims and their equivalents.

Unless otherwise expressly stated, it is in no way intended that any method set forth herein be construed as requiring that its steps be performed in a specific order, nor that specific orientations be required with any apparatus. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect.

1. A screen cylinder comprising:
a screening media having an inflow side and an outflow side, the screening media being cylindrical and formed of a plurality of circumferentially spaced axially extending slots formed between axially extending bars, the axially extending bars of the screening media having an inflow surface facing the inflow side wherein the inflow surface extends lengthwise in an axial direction and widthwise in a circumferential direction relative to the screening media;
the screening media having an inflow end and an outflow end axially opposite the inflow end, the axially extending bars extending from the inflow end to the outflow end;
wherein the axially extending bars comprise a spray-on wear resistant coating on the inflow surface of the screening media, the wear resistant coating forming a substantially uniform coated area between an area on the inflow surface of a bar proximate a first slot to an area on the inflow surface of a bar proximate a second slot, and wherein (i) the substantially uniform coated area at multiple axial locations is of a substantially uniform thickness along the inflow surface in a direction normal to the axial direction while (ii) the substantially uniform coated area increases in thickness at multiple axial locations along the axial direction, such that the wear resistant coating is thicker on said bars towards the outflow end of the screening media compared to the wear resistant coating located on said bars towards the inflow end of the screening media.

2. The screen cylinder of claim 1, wherein substantially uniform coated area varies in thickness along the inflow surface in a direction normal to the axial direction by an amount of twenty percent or less of an average thickness, preferably fifteen percent or less of an average thickness, preferably by an amount of ten percent or less of an average thickness, and/or more preferably five percent or less of an average thickness.

3. The screen cylinder of claim 1, wherein the substantially uniform coated area wear resistant coating comprises a material of a hardness greater than a base material of said bars.

4. The screen cylinder of claim 1, wherein the axially extending slots have a slot width defined by the minimum distance between adjacent bars at an area between said bars which are uncoated by the wear resistant coating such that the slot width is not reduced by said wear resistant coating at said area.

5. The screen cylinder of claim 1, wherein the minimum distance between coated areas of adjacent bars is greater than or equal to a slot width defined by the minimum distance between adjacent bars at an area between said bars which are uncoated by the wear resistant coating such that the slot width is not reduced by said wear resistant coating at said area.

6. The screen cylinder of claim 1, wherein the substantially uniform coated area begins at the inflow surface of a bar proximate a first slot at a location within 0.0 to 0.7 mm, preferably within 0.0 to 0.5 mm, and more preferably within 0.0 to 0.2 mm from an upper ridge area, the upper ridge area being the area between a first slot surface of a bar and the inflow surface of a bar, and extends to the inflow surface of the bar proximate a second slot at a location within 0.0 to 0.7 mm, preferably within 0.0 to 0.5 mm, and more preferably within 0.0 to 0.2 mm from a transition area, the transition area being the area between a second slot surface of a bar and the inflow surface of a bar.

7. The screen cylinder of claim 1, wherein the wear resistant coating thickness progressively increases in the axial direction from towards the inflow end to outflow end along the axial length of the bars.

8. The screen cylinder of claim 1, wherein the wear resistant coating thickness progressively increases linearly in the axial direction from a portion of the bars towards the inflow end to the outflow end along the axial length of the bars.

9. The screen cylinder of claim 1, wherein the wear resistant coating progressively increases in the axial direction in a step-wise shape from a portion of the bars towards the inflow end to the outflow in the outflow direction along the axial length of the bars.

10. The screen cylinder of claim 1, wherein the thickness increases in the axial direction in a wave form shape from a portion of the bars towards the inflow end to the outflow in the outflow direction along the axial length of the bars.

11. The screen cylinder of claim 1, wherein the thickness of substantially uniform coated area increases in the axial direction from a thickness of 30 or more microns to a thickness of 300 or less microns, and preferably from a thickness of 75 or more microns to a thickness of 150 or less microns.

12. A method of manufacturing a screen cylinder comprising:
forming a screening media having an inflow side and an outflow side, the screening media being cylindrical and having a plurality of circumferentially-spaced axially extending slots formed between axially extending bars, the axially extending bars of the screening media having an inflow surface facing the inflow side wherein the inflow surface extends lengthwise in an axial direction and widthwise in a circumferential direction relative to the screening media;
wherein the screening media comprises an inflow end and an outflow end axially opposite the inflow end; and
applying a sprayed wear resistant coating on the inflow surface of the axially extending bars of the screening media, the wear resistant coating forming a substantially uniform coated area between an area on the inflow surface of a bar proximate a first slot to an area on the inflow surface of a bar proximate a second slot, and wherein (i) the substantially uniform coated area at multiple axial locations is of a substantially uniform thickness along the inflow surface in a direction normal to the axial direction while (ii) the substantially uniform coated area increases in thickness at multiple axial locations along the axial direction, such that the wear resistant coating is thicker on said bars towards the outflow end of the screening media compared to the wear resistant coating located on said bars towards the inflow end of the screening media.

13. The method of claim 12 wherein applying the wear resistant coating comprises:
spraying the wear resistant coating on the inflow surface of the axially extending bars of the screening media using a spray nozzle;
passing the spray nozzle axially along the screen cylinder to apply the wear resistant coating on the inflow surface of the axially extending bars of the screening media; and
varying the number, length and/or speed of passes of the spray nozzle while spraying the wear resistant coating to vary the thickness of the wear resistant coating.

14. The method of claim 11, wherein the substantially uniform thickness along the inflow surface in a direction normal to the axial direction varies by an amount of twenty percent or less from an average thickness, preferably by an amount of fifteen percent or less from an average thickness, preferably by an amount of ten percent or less from an average thickness, and/or more preferably by an amount less than 5 per cent or less form the average thickness.

15. The method of claim 11, wherein the axially extending slots have a slot width defined by the minimum distance between adjacent bars at an area between said bars which are uncoated by the wear resistant coating such that the slot width is not reduced by said wear resistant coating at said area.

16. The method cylinder of claim 11, wherein the minimum distance between coated areas of adjacent bars is greater than or equal to a slot width defined by the minimum distance between adjacent bars at an area between said bars which are uncoated by the wear resistant coating such that the slot width is not reduced by said wear resistant coating at said area.

17. The method of claim 11, wherein the wear resistant coating comprises a material of a hardness greater than a base material of said bars.

18. The method of claim 11, wherein the substantially uniform coated area begins at the inflow surface of a bar proximate a first slot at a location within 0.0 to 0.7 mm, preferably within 0.0 to 0.5 mm, and more preferably within 0.0 to 0.2 mm from an upper ridge area, the upper ridge area being the area between a first slot surface of a bar and the inflow surface of a bar, and extends to the inflow surface of the bar proximate a second slot at a location within 0.0 to 0.7 mm, preferably within 0.0 to 0.5 mm, and more preferably within 0.0 to 0.2 mm from a transition area, the transition area being the area between a second slot surface of a bar and the inflow surface of a bar.

19. (canceled)

20. The method of claim 13, wherein the substantially uniform coated area increases from a thickness of 30 or more microns to a thickness of 300 or less microns in the axial direction or from a thickness of 75 or more microns to a thickness of 150 or less microns in the axial direction

21. The method of claim 11, wherein the screen cylinder rotates while spraying the wear resistant coating.

22. The method of claim 11, wherein the speed of rotation of the screen cylinder varies based upon the position of the spray nozzle.
